(19) United States
(12) Patent Application Publication
(10) Pub. No.: US 2015/0095237 A1
(43) Pub. Date: Apr. 2, 2015

(54) License Management System

(71) Applicant: Infinera Corp., Annapolis Junction, MD (US)

(72) Inventors: Dharmendra Naik, San Jose, CA (US); Lam Dinh Hoang, San Jose, CA (US); Kiran Kumar Dintakurthi, Fremont, CA (US); Kasi Viswanadham Pydi, Karnataka (IN); Kamalakannan Govindarajan, Basaweshwara Nagar (IN)

(21) Appl. No.: 14/041,590

(22) Filed: Sep. 30, 2013

(51) Int. Cl. G06Q 10/00; H04L 29/08

(52) U.S. Cl. CPC G06Q 10/00; H04L 67/12
USPC 705/59

(57) ABSTRACT

A license management system coupled with a network and having at least one processor capable of executing processor-executable code coupled with a non-transitory processor-readable medium storing processor-executable code for causing the at least one processor to: (1) read a current licensing transaction tamp value of a network element and a restored licensing transaction stamp value of the network element; (2) determine whether a discrepancy exists between the restored licensing transaction stamp value and the current licensing transaction stamp value; and (3) in response to the discrepancy between the restored licensing transaction stamp value and the current licensing transaction stamp value, transmit an alert to a user via an output port.

### FIELD OF THE DISCLOSURE

The disclosure generally relates to license management systems and methods to allow network operators and vendors to efficiently and accurately manage license configurations of licensed network elements as the license configurations of licensed network elements change during network operations.

### BACKGROUND

Communication networks, such as computer networks, cable networks, satellite networks, cellular networks, local area networks, wireless networks, the Internet, virtual private networks, metropolitan networks, public switched telephone networks, and optical networks, for example, are becoming increasingly important in carrying ever-increasing amounts of data between users, computer systems, and/or databases worldwide. Networks generally include multiple network elements or devices such as network nodes, which are dispersed geographically and are coupled to one another in compliance with one or more of many networking protocols, standards, and infrastructures, which specify how signals and\or data may be exchanged between network elements in the same network and/or between network elements in different networks. Examples of network protocols and infrastructures include Ethernet, TCP/IP, and WLAN, as will be appreciated by a person of ordinary skill in the art having the benefit of the instant disclosure.

Multiple network operators such as internet service providers, cable network operators, mobile phone operators, search engine companies, social network companies, internet hosting companies, and cloud storage companies, build, maintain, and operate a variety of networks and/or provide networking services to users or businesses. Network operators generally purchase a variety of network elements (NE or NEs), such as network nodes, gateways, servers, optical modules, interconnects, bridges, amplifiers, cables, optical fibers, splitters, and other hardware and/or software components and devices from third-party vendors, and incorporate such network elements into their respective networks to provide networking services to their customers.

Some network elements include processors executing software and/or firmware code or instructions, and are provided to network operators under the terms of various license agreements as licensable hardware or licensed network elements. Network operators carry out a number of licensing transactions for NEs, such as activating licenses or license keys for NEs before the NEs can be used in their respective networks. For example, as network operators activate a newly implemented NE or reactivate a previously deactivated NE, network operators may communicate activating a license key to the appropriate vendor in some way, such as by visiting the vendor's website, or by calling the vendor's customer service representatives. Similarly, other licensing transactions include removing or otherwise deactivating a NE from their network, in which case network operators may communicate deactivating the license key for the removed or deactivated NE to the appropriate vendor.

To enable network operators to carry out licensing transactions (e.g., activating and/or deactivating license keys) and to allow NE vendors to keep track of and manage the license configurations of the NEs sold to network operators and/or activated on a network operator's network, a license store and/or a master database is generally maintained by vendors and includes license configurations (e.g., activated licenses and/or license keys) for the NEs provided to network operators by the vendor. Network operators likewise typically use a license manager and/or maintain a local license database to manage the license configurations of the NEs on their network. The local license database may be synchronized with the master database (e.g., periodically or continuously), as desired, to ensure proper billing by vendors and compliance with applicable license agreements by network operators.

During normal network operations, network operators reconfigure NEs, such as physically moving NEs between different locations in the network, activating new NEs at various locations in the network, deactivating NEs from various locations in network, and/or temporarily storing deactivated NEs (e.g., in a spare depot). Because some NEs include software and/or firmware, network operators often update, upgrade, reconfigure, backup, customize, monitor, diagnose, or otherwise modify or interact with the NEs' software and/or firmware, which includes backup operations (e.g., saving a backup image of the NE including the license configuration of the NE), and restore operations (e.g., restoring a backup image of the NE in the event of failure). In some cases where a NE fails, the network operator may take various steps to repair the NE and restore service, such as diagnosing or troubleshooting the failed NE, rebooting the failed NE, restoring previous versions, images, or configurations of software and/or firmware of the failed NE which may include restoring a backup image including a saved license configuration for the NE, for example.

In some instances, where the license configuration of a NE has been changed since the last backup operation was carried out by the network operator (e.g., a license key has been added or removed) and the license configuration change was synchronized with the master database of the respective vendor, a restore operation carried out by the network operator may create a mismatch between the current license configuration of the NE (i.e., the restored backup license configuration) and the license configuration of the NE in the master database of the respective vendor. This mismatch may increase licensing costs for network operators and may cause delayed or missed renewals of licenses for NEs and/or operation of NEs in violation of license agreements. Coordinating the license configurations of NEs in the network operator's network as backup and restore operations are carried out with the license configurations of the NEs in the master database of the NE vendor imposes significant burdens on both parties, and may result in license-compliance related disputes and billing inaccuracies.

To that end, what is needed is a license management system and method to enable network operators and vendors to coordinate, update, and manage license configurations of NEs as the license configurations of the NEs in the network change during network operations.

### SUMMARY OF THE DISCLOSURE

In one aspect, the inventive concepts disclosed herein are directed to a license management system coupled with a network and having at least one processor capable of executing processor-executable code coupled with a non-transitory processor-readable medium storing processor-executable code for causing the at least one processor to: (1) read a current licensing transaction stamp value for a network element and a restored licensing transaction stamp value for the network element; (2) determine whether a discrepancy exists between the restored licensing transaction stamp value and the current licensing transaction stamp value; and (3) in response to a discrepancy between the restored licensing transaction stamp value and the current licensing transaction stamp value existing, transmit an alert to a user via an output port.

In another aspect, the inventive concepts disclosed herein are directed to a method of managing a license configuration of a network element, comprising: (1) reading, by at least one processor of a license manager, a current licensing transaction stamp value of a network element and a restored licensing transaction stamp value of the network element; (2) determining by the at least one processor, whether a discrepancy exists between the restored licensing transaction stamp value and the current licensing transaction stamp value; and (3) in response to a discrepancy existing between the restored licensing transaction stamp value and the current licensing transaction stamp value, transmitting an alert by the license manager to a user via an output port.

### BRIEF DESCRIPTION OF THE DRAWINGS

The accompanying drawings, which are incorporated in and constitute a part of this specification, illustrate one or more implementations described herein and, together with the description, explain these implementations. In the drawings:

FIG. 1 is a diagram of an exemplary embodiment of a license management system according to the inventive concepts disclosed herein.

FIG. 2 is a diagram of an exemplary embodiment of a license key activation on a network element by the license management system of FIG. 1 according to the inventive concepts disclosed herein.

FIG. 3 is a diagram of an exemplary embodiment of a backup operation of a network element carried out by the license management system of FIG. 1 according to the inventive concepts disclosed herein.

FIG. 4 is a diagram of an exemplary embodiment of a license key removal operation on a network element carried out by the license management system of FIG. 1 according to the inventive concepts disclosed herein.

FIG. 5 is a diagram of an exemplary embodiment of a restore operation of a network element carried out by the license management system of FIG. 1 according to the inventive concepts disclosed herein.

FIG. 6 is a diagram of an exemplary embodiment of a method of managing a license configuration of a network element carried out by the license management system of FIG. 1 according to the inventive concepts disclosed herein.

FIG. 7 is a diagram of an exemplary embodiment of a method of managing a license configuration of a network element by the license management system of FIG. 1 according to the inventive concepts disclosed herein.

### DETAILED DESCRIPTION OF EXEMPLARY EMBODIMENTS

The following detailed description refers to the accompanying drawings. The same reference numbers in different drawings may identify the same or similar elements or features.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

As used herein, “network element,” “network elements,” “NE,” or “NEs” is intended to include licensable hardware or licensable network devices or elements including software and/or firmware and/or components provided to a network operator under the terms of a license agreement by a vendor, and configured to enable and/or disable one or more functions or features (e.g., available bandwidth) based on one or more license keys being added or activated on the NE and/or removed or deactivated from the NE.

As used herein “licensing transaction” includes the adding or activation of a license or a license key on a NE and/or the removing or deactivation of a license key from a NE.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

The inventive concepts disclosed herein are directed to license management systems and methods for enabling NE vendors and network operators to manage license configurations of NEs through various licensing transactions (e.g., activation, deactivation, and transfer of license keys) as NEs are configured and/or as NE's are relocated, upgraded, installed, uninstalled, and/or stored by network operators.

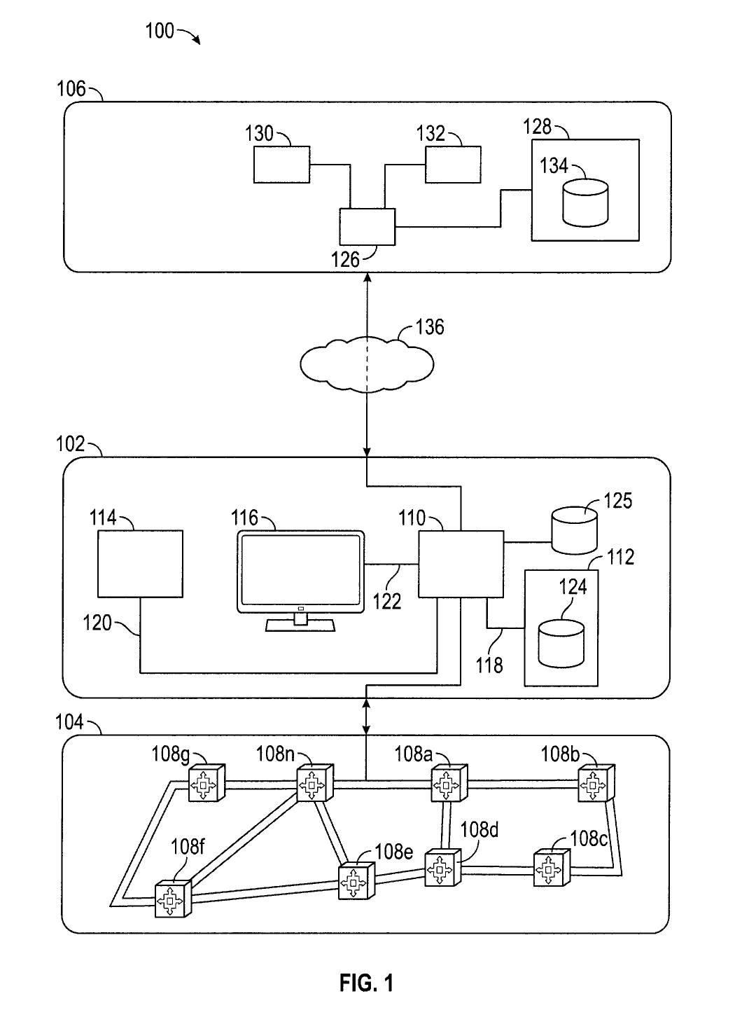

Referring now to the drawings, and in particular to FIG. 1, shown therein is an exemplary embodiment of a license management system 100 according to the inventive concepts disclosed herein. The license management system 100 may include a license manager 102 coupled with a network 104, and a license store 106. The license store 106 may be deployed on the premises and/or may be under the control of a vendor of one or more NEs 108a-n, and the license manager 102 may be deployed on the premises and/or may be under the control of a network operator of the network 104.

The network 104 may include a plurality of NEs 108a-n coupled with one another so that data and/or signals may be bi-directionally exchanged by the NEs 108a-n. The network 104 may be an optical network, a cable network, a wireless network, a hybrid fiber-coaxial network, a circuit-switched network, or combinations thereof, for example, and may be constructed in compliance with any desired networking infrastructure(s) and/or protocol(s) such as wave division multiplexing, dense wavelength division multiplexing, or TCP/IP, for example.

The NEs 108a-n may be implemented as network devices or elements, such as network nodes, gateways, servers, optical line modules, interconnects, bridges, amplifiers, cables, optical fibers, splitters, network chassis, and other hardware and/or software components and devices. The NEs 108a-n may include a processor and a non-transitory processor-executable code which may store processor-executable code and/or data as will be appreciated by persons of ordinary skill in the art having the benefit of the instant disclosure.

The license manager 102 may be implemented as a computer system or a server coupled with the network 104, and may or may not be physically co-located with the network 104. The license manager 102 may include at least one processor 110 coupled with a non-transitory processor-readable medium 112, an input device 114, and an output device 116, all of which can be partially or completely network-based or cloud-based, and may not necessarily be located in a single physical location.

The processor 110 can be implemented as a single or multiple processors working together to execute processor executable code including the logic described herein and may be implemented as a digital signal processor (DSP), a central processing unit (CPU), a field programmable gate array (FPGA), a microprocessor, a multi-core processor, and combinations thereof. The processor 110 is operably coupled with the non-transitory processor-readable medium 112 via a path 118 which can be implemented as a data bus allowing bi-directional communication between the processor 110 and the non-transitory processor-readable medium 112.

The processor 110 is capable of communicating with the input device 114 and with the output device 116 via paths 120 and 122 (e.g., one or more data busses). The processor 110 is capable of reading and/or executing processor executable code stored in the one or more non-transitory processor-readable medium 112 and/or of creating, manipulating, altering, and storing computer data structures into the non-transitory processor-readable medium 112.

The non-transitory processor-readable medium 112 may store data and processor-executable code and may be implemented as non-transitory computer memory, such as random access memory (RAM), a CD-ROM, a hard drive, a solid state drive, a flash drive, a memory card, a DVD-ROM, a floppy disk, an optical drive, and combinations thereof, for example. The non-transitory processor-readable medium 112 may be implemented as a “cloud memory” e.g., two or more non-transitory processor-readable mediums 112 which are partially, or completely based on or accessed using a network such as the network 104, for example. Further, the processor 110 may not communicate directly with the non-transitory processor-readable medium 112, but may communicate with another processor 110 communicating with the non-transitory processor-readable medium 112 over a network such as the network 104, for example.

In some exemplary embodiments, the non-transitory processor-readable medium 112 may store a license database 124 indicative of license configurations for the NEs 108a-n managed by the license manager 102 (e.g., at least one license key activated on or otherwise associated with the respective NE 108a-n and a licensing transaction stamp for the respective NE 108a-n), and a backup database 125 including information indicative of saved backup images of NEs 108a-n managed by the license manager 102 including backup license configurations and other backup data for the NEs 108a-n. License configuration data in the license database 124 and/or in the backup database 125 may be stored as data structures or data tables and may be time-stamped in some exemplary embodiments of the inventive concepts disclosed herein as will be described below.

As will be appreciated by persons of ordinary skill in the art, in some embodiments one or both of the license database 124 and the backup database 125 may be implemented as separate databases (e.g., stored in non-transitory processor-readable medium separate from the non-transitory processor-readable medium 112 and accessible by the processor 110 over a computer network), for example.

The input device 114 may pass data to the processor 110, and may be implemented as a keyboard, a mouse, a touch-screen, a camera, a cellular phone, a tablet, a smart phone, a PDA, a microphone, a network adapter, a computer port, an input port, an output port, an Ethernet port, a wireless port, a CD-drive, a USB-port, and combinations thereof, for example. The input device 114 may be located in the same physical location as the license manager 102, or may be remotely located and/or partially or completely network-based.

The output device 116 may pass data from the processor 110 to a user (e.g., a network operator), such that the information is in a form that can be perceived by the user. For example, the output device 116 can be implemented as a server, a computer monitor, a cell phone, a smartphone, a tablet, a speaker, a website, a personal digital assistant, a fax, a printer, a projector, a laptop monitor, an input port, an output port, and combinations thereof. The term “pass” as used herein may refer to either push technology, or to pull technology, and to combinations thereof. The output device 116 can be physically co-located with the license manager 102, or can be located remotely from the license manager 102, and may be partially or completely network based (e.g., a website). The term “user” is not limited to a human, and may include a human, a computer, a host system, a smart phone, a tablet, and combinations thereof, for example.

The license store 106 may include at least one processor 126 coupled with a non-transitory processor-readable medium 128, an input device 130, and an output device 132.

The processor 126 may be implemented similarly to the processor 110, and may execute the licensed management system 100 logic as will be described below.

The non-transitory processor-readable medium 128 may be implemented similarly to the non-transitory processor-readable medium 112 and may store a master database 134 indicative of license configurations of one or more NEs 108a-n provided to one or more network operators.

The input device 130 may be implemented and may function similarly to the input device 114, and the output device 132 may be implemented and may function similarly to the output device 116, for example. In some exemplary embodiments, the output device 132 may be coupled with the input device 114 such that data may be bi-directionally exchanged between the processor 110 and the processor 126, the processor 110 and the non-transitory processor-readable medium 128, the processor 126 and the non-transitory processor-readable medium 112, and combinations thereof.

Further, in some embodiments, the license management system 100 may operate in a connected mode where the processor 126 and the processor 110 are coupled or connected with one another over a computer network 136 (e.g., the Internet) so that the processor 126 and the processor 110 bi-directionally exchange one or more signal and/or data via one or more computer ports over the computer network 136 to synchronize data in the master database 134 and data in the license database 124 in real-time or substantially in real-time.

In some embodiments, the license management system 100 may operate in a disconnected mode, where the processor 126 and the processor 110 are not automatically connected and the master database 134 and the license database 124 are not automatically synchronized but are manually synchronized, such as by a user exporting a file (e.g., indicative of the current license configuration of a NE 108a-n) from the license database 124, and importing the file into the master database 134, such as by logging onto a website provided by the license store 106 (e.g., using the computer network 136 and/or a secure networking protocol such as SSL or HTTPs, or via a virtual private network or tunnel).

In some embodiments where the license management system 100 operates in the disconnected mode, a portable non-transitory processor-readable medium (not shown), such as a CD-ROM, a flash-drive, a memory stick, a solid-state drive, or a hard-drive, may be implemented to transfer license configuration data and/or processor-executable instructions between the processor 110 and/or 126 and/or the non-transitory processor-readable mediums 112 and/or 128. In some embodiments where the license management system 100 operates in the disconnected mode the file may be transferred via machine-to-machine communication such as email.

The master database 134 may include license configuration information for each of the NE 108a-n, including active licenses or license keys on each NE 108a-n, and inactive or deactivated licenses or license keys owned by the network operator. In some cases, license information in the master database 134 may be tied to, or otherwise associated with a NE 108a-n model number, specifications, capacity, or other information for a particular NE 108a-n. Further, license information may be associated with a particular network operator, a particular NE 108a-n, and/or with a particular location of the NE 108a-n in the network operator's network 104 (e.g., a particular identification such as a machine access control or MAC address or an internet protocol or IP address, or a particular location such as a chassis where a NE 108a-n is located in the network 104).

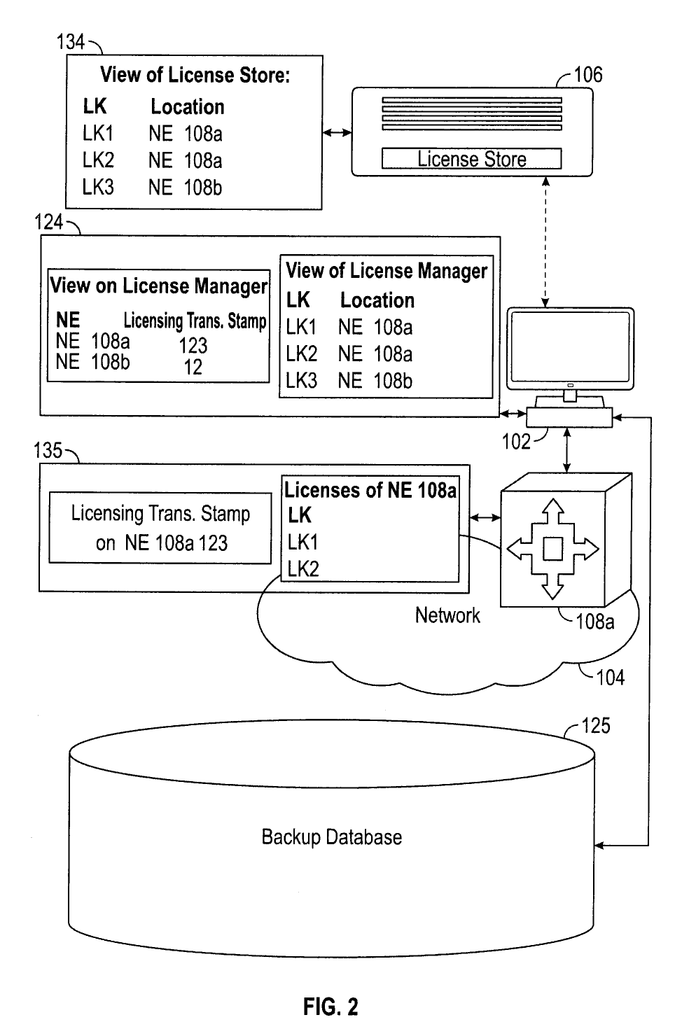

Referring now to FIG. 2, in one embodiment, an initial license key activation for a NE 108a may be carried out by the license management system 100 as follows.

The network operator may install or deploy the NE 108a in the network 104. The license manager 102 may transmit a signal to the license store 106 (e.g., the processor 110 may transmit one or more signals over a computer network such as the computer network 136 to the processor 126, or the network operator may export a file from the license manager 102 and import the file to the license store 106) indicative of a license key request for the NE 108a.

The license key request may include information uniquely identifying the NE 108a (e.g., NE ID), and information uniquely identifying a location in the network 104 where the NE 108a is installed (e.g., NE location ID) and/or other pertinent information identifying the network operator and/or the network 104. For example, the NE ID may be a MAC address, an IP address, or any other suitable identifier uniquely identifying the NE 108a, and the NE location ID may be a unique location such as a geographical location and/or an identification of a chassis in the network 104 where the NE 108a is located.

The license store 106 may receive the license key request for the NE 108a from the license manager 102 (e.g., over the computer network 136), and may store information from the license key request in the non-transitory processor-readable medium 128.

In response to the license key request, the license store 106 may generate an activation code which may be unique for the NE 108a and may include or may be linked to information indicative of a license key (e.g., LK1), a NE ID uniquely identifying the NE 108a, and a NE location ID uniquely identifying the location in the network 104 where the NE 108a is installed or located, for example, to enable the NE 108a to validate the activation code as will be described below. In some embodiments, the activation code may omit one or more of: the license key (e.g., LK1), the NE ID, and the NE location ID. The license store 106 may transmit the activation code to the appropriate license manager 102 such as by transmitting a signal over the computer network 136 to the license manager 102 indicative of the activation code.

The license store 106 may also store licensing configuration information for the NEs 108a-n including license configuration of the NE 108a having information from the license key request and the activation code in the master database 134. For example, the license store 106 may associate the NE ID for the NE 108a and/or the NE location ID for the NE 108a with information indicative of license keys activated on or associated with the NE 108a. As shown in FIG. 2, the license store 106 stores information indicative of LK1 and LK2 being on NE 108a, and of LK3 being on NE 108b, for example, which information is stored in the master database 134. The master database 134 may include such license configuration information for each NE 108a-n sold by a vendor operating the license store 106. The master database 134 may serve as the master database with which one or more license databases 124 are synchronized by one or more license managers 102 to ensure proper billing and license terms compliance by operators of the license managers 102, for example.

The license manager 102 may receive data indicative of the activation code generated by the license store 106 (e.g., as a data signal transmitted over a computer network via a computer port or as a file imported into the license manager 102). The license manager 102 may store the activation code in the non-transitory processor-readable medium 112. The license manager 102 may transmit a licensing transaction message, signal, or command to the NE 108a, which may include the activation code.

The network element 108a may receive the activation code, generate a unique licensing transaction stamp value unique for each licensing transaction for the NE 108a, and/or may change the value or update an existing licensing transaction stamp value for each licensing transaction (e.g., each time the license configuration of the NE 108a is changed by adding and/or removing a license key) such as incrementally, randomly, by a predetermined step or formula, or combinations thereof, for example. The licensing transaction stamp value may be transmitted to the license manager 102 by the network element 108a. For example, the licensing transaction stamp value may be a number, an alphanumeric string, a flag, a timestamp, or combinations thereof. The license manager 102 may store the current or most recent license configuration and the current or most recent licensing transaction stamp value for the NE 108a in the license database 124. For example, as shown in FIG. 2, the license database 124 may include information showing the license configuration of NE 108a as including LK1 and LK2, and the licensing transaction stamp value of NE 108a as being 123. Further, a license configuration of a NE 108b may be stored in the license database 124 as having LK3 on the NE 108b and a licensing transaction stamp value of 12.

The NE 108a may receive the licensing transaction message including the activation code from the license manager 102 and may validate the activation code (e.g., by decoding the activation code and determining whether LK1 is valid, whether the NE ID correctly identifies the NE 108a, and/or whether the NE location ID correctly identifies the location of the NE 108a in the network 104).

In response to successfully validating the activation code, the NE 108a may activate the license key(s) included in the activation code (LK1 in this case) and may provide one or more features (e.g., increase bandwidth or make additional bandwidth available) based on the activation of the license key(s). The NE 108a may generate a unique licensing transaction stamp having a unique licensing transaction stamp value, and/or may update the licensing transaction stamp value of an existing licensing transaction stamp in response to successfully validating the activation code and/or updating the license configuration. The NE 108a may store a local license configuration in the local license database 135 (e.g., a non-transitory processor-readable medium). As shown in FIG. 2, the NE 108a has a local license configuration showing LK1 and LK2 being active on the NE 108a, and a licensing transaction stamp value of 123. The NE 108a may transmit one or more signals to the license manager 102 indicative of a successful licensing transaction (e.g., a successful validation of the activation code) and of the newly enabled feature(s), for example. The NE 108a may additionally transmit a signal indicative of the current license configuration of the NE 108a and of the current licensing transaction stamp value of the NE 108a to the license manager 102. When the license management system 100 operates in the connected mode, the license database 124 and the master database 134 may be automatically synchronized (e.g., in real time), continuously, periodically, or manually as will be appreciated by persons of ordinary skill in the art having the benefit of the instant disclosure. Conversely, when the license management system 100 operates in the disconnected mode, the license database 124 and the master database 134 may be manually synchronized by an operator of the license manager 102, such as on a preset schedule, in response to certain predetermined events, or in response to an alert generated by the license manager 102 as will be described below.

As will be appreciated by persons of ordinary skill in the art having the benefit of the instant disclosure, in some cases the network operator may wish to remove or deactivate a license key from a NE 108a-n, or may wish to activate more than one license key on a particular NE 108a-n. For example, to activate an additional license key on the NE 108a, the license manager 102 may repeat the above license key activation steps one or more times.

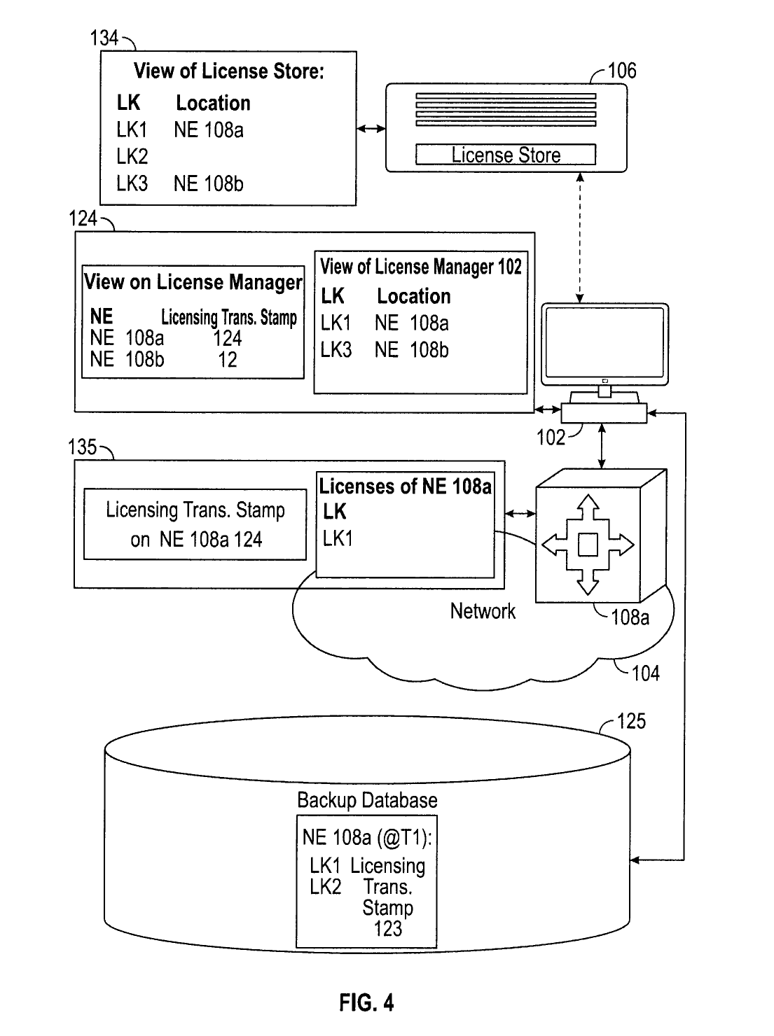

To deactivate or remove a license key from a NE 108a-n, the network operator may use the license manager 102 to transmit a licensing transaction message indicative of a license key removal request or command (e.g., remove LK2) to the NE 108a as will be described with reference to FIG. 4 below.

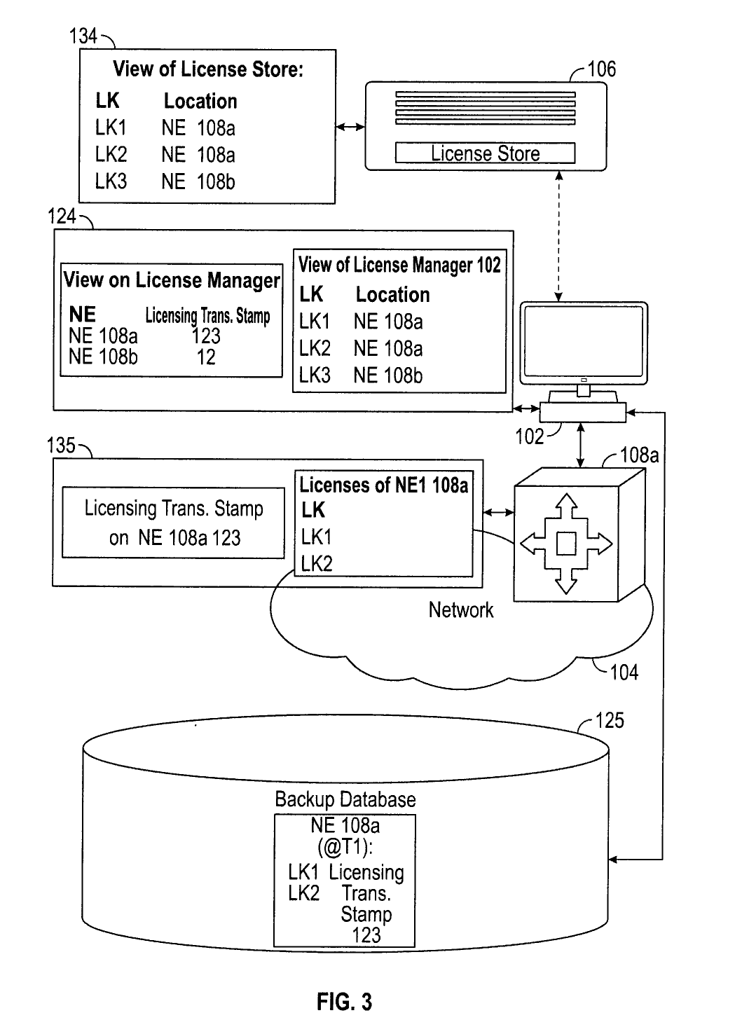

Referring now to FIG. 3, an exemplary embodiment of a backup operation carried out by the license management system 100 is shown therein. As part of normal network operations (e.g., according to best industry practices), network operators may make one or more backup copies or images of NEs 108a-n on the network 104 and may store the backup copies or images of the NEs 108a-n in the backup database 125. The backup for each NE 108a-n may include the license configuration of the NE 108a-n indicative of license keys active on each NE 108a-n, and of the respective licensing transaction stamp value at the instant in time when the backup image of the NE 108a-n is taken, and/or a time stamp indicative of the instant in time the backup image was taken. For example, as shown in FIG. 3, a backup image of the NE 108a stored in the backup database 125 is indicative of the license configuration of the NE 108a at an instant in time T1 as including LK1 and LK2 and a licensing transaction stamp value of 123.

The backup operation may begin with the license manager 102 transmitting a backup request, message, or command to the NE 108a at an instant in time T1. In response, the license manager 102 may receive information indicative of an image of the NE 108a at T1 including the license configuration of the NE 108a at T1 having a licensing transaction stamp value at T1. The license manager 102 may store the backup image of the NE 108a at T1 in the backup database 125. In some embodiments, the NE 108a may store the backup image of the NE 108a at T1 in the backup database 125. The backup operation may be carried out on a schedule, as desired by network operators, or as specified by industry standards or best practices. One or more backup images of one or more of the NEs 108a-n may be stored in the backup database 125 in a similar manner. In some exemplary embodiments, the backup operation may be carried out by the NE 10, and the NE 108a may store the backup image of the NE 108a in the backup database 125 and/or in the local license database 135.

Referring now to FIG. 4, the network operator may modify the license configuration of the NE 108a at any time as part of normal network operations, such as for example at an instant in time T2 which is later than T1. For example, at the instant in time T2 the network operator may remove the license key LK2 from the NE 108a, such as by the license manager 102 transmitting a licensing transaction message indicative of a license key removal request an to the NE 108a at the instant in time T2.

The NE 108a may delete LK2 (and disable one or more corresponding features) and may update and store a local license configuration including the removal of LK2. The NE 108a may update the current licensing transaction stamp value (e.g., to a value of 124) in the local license database 135. The NE 108a may send a confirmation message or signal indicative of the successful licensing transaction and of the updated current license configuration of the NE 108a to the license manager 102. As will be appreciated by persons of ordinary skill in the art, the updated licensing transaction stamp value transmitted to the license manager 102 is different from and/or incrementally changed relative to a licensing transaction stamp value sent to the license manager 102 by the NE 108a in response to a previous licensing transaction message (e.g., at T1).

The license manager 102 may store the updated license configuration for the NE 108a indicative of the removal of LK2 and of the updated licensing transaction stamp value at T2 in the license database 124.

The license manager 102 may further transmit a signal indicative of the removal of LK2 from the NE 108a-n to the license store 106. The license store 106 may update the master database 134 accordingly, to reflect the current license configuration of the NE 108a.

In the example shown in FIG. 4, the NE 108a has two license keys (e.g., LK1 and LK2) active thereon and a corresponding license configuration (LK1, LK2) having a licensing transaction stamp value of 123. The license manager 102 may remove or deactivate LK2 from the NE 108a (e.g., by sending a license key removal signal or request to the NE 108a over the network 104 at T2), update the license configuration for the NE 108a to (LK1), receive a signal indicative of the updated current licensing transaction stamp value (e.g., 124) from the NE 108a, and transmit updated license information for the NE 108a to the license store 106, and/or store the updated license configuration for the NE 108a in the license database 124.

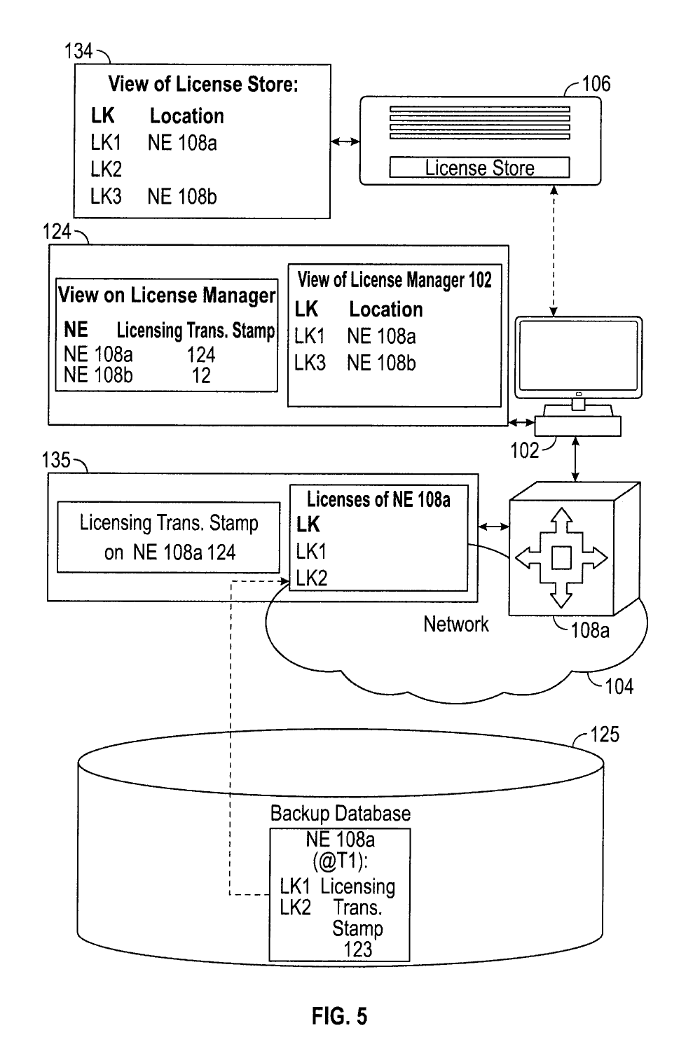

Referring now to FIG. 5, in some cases network operators may initiate a restore operation to restore a previously saved backup image of a NE 108a. For example, the license manager 102 may transmit a restore command or message to the NE 108a indicative of a particular backup image from the backup database 125 (e.g., the backup image from T1) to be restored and/or data indicative of the backup image to be restored at an instant in time T3 which is later than T2.

In response, the NE 108a may access the backup database 125 and/or the backup image information provided by the license manager 102 and may restore the backup image (in this instance the backup image from T1) and transmit a successful restore signal to the license manager 102 indicative of successfully restoring the backup image at T1. In some exemplary embodiments, the successful restore signal may include information indicative of the restored license configuration and of the restored licensing transaction stamp value (e.g., having a value of 123) of the NE 108a which is now the current licensing transaction stamp value of the NE 108a.

However, in this example the current license configuration and/or the current licensing transaction stamp value for the NE 108a stored in the license database 124 are from T2 (e.g., LK1 and/or 124), and differ from the restored license configuration and/or restored licensing transaction stamp value of NE 108a from T1 (e.g., LK1 and LK2, and/or 123).

In response to receiving the successful backup restore signal from the NE 108a and the restored (or now current) licensing transaction stamp value from the NE 108a, the license manager 102 may compare the restored license configuration and/or the restored licensing transaction stamp value of the NE 108a (in this case LK1 and LK2 and 123), with the current or most recent license configuration and/or licensing transaction stamp value of the NE 108a stored in the license database 124 (in this case LK1 and 124), to determine if a discrepancy exists between the two. In response to a discrepancy existing between the restored license configuration and the license configuration stored in the license database 124, an alert may be generated by the license manager 102 and transmitted to a user (e.g., via one or more output ports). In some embodiments, the alert may be transmitted to the user in response to the restored licensing transaction stamp value (e.g., having a value 123) and the current licensing transaction stamp value (e.g., having a value 124) being different from one another. In some embodiments, the license manager 102 may block or disable one or more features or functions of the NE 108a in response to a discrepancy existing between the current license configuration for the NE 108a stored in the license database 124 and the restored license configuration (e.g., discrepancy between the current license configuration and the restored license configuration and/or a discrepancy between the current licensing transaction stamp value and the restored licensing transaction stamp value).

Where the license management system 100 operates in the connected mode, the license configuration of the NE 108a may be automatically synchronized with the master database 134, and the license manager 102 may resolve the discrepancy between the master database 134 and the license database 124 by removing or adding license keys such as by sending a licensing transaction message to the NE 108a. Once the license manager 102 receives a successful licensing transaction signal from the NE 108a along with a current licensing transaction stamp value, the license manager 102 may unblock or re-enable one or more features of the NE 108a and/or allow the NE 108a on the network 104. In some instances where the license management system 100 operates in the disconnected mode, a user such as a network operator may synchronize the license configuration of the NE 108a with the master database 134 by exporting and importing one or more files, for example. Once the synchronization is complete, the license manager 102 may update the current license configuration of the NE 108a and the current licensing transaction stamp value of the NE 108a stored in the license database 124.

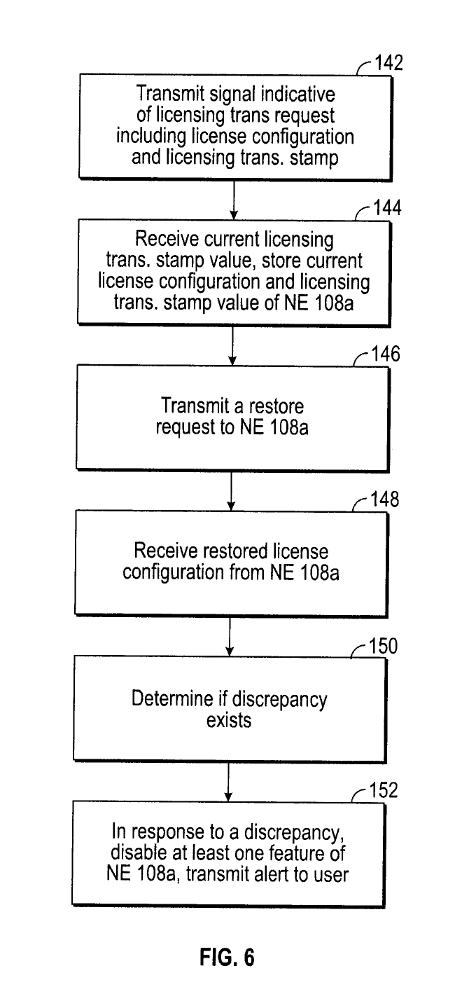

Referring now to FIG. 6, shown therein is a diagram of an exemplary embodiment of a method 140 carried out by the license management system 100 according to the inventive concepts disclosed herein.

In a step 142, at least one processor (e.g., the processor 110 of the license manager 102) may transmit at least one signal over the network 104 to a first network element 108a coupled with the network 104, the signal indicative of at least one licensing transaction message including a current license configuration.

In a step 144, the processor 110 may receive a current licensing transaction stamp value from the NE 108a and may store the current license configuration and the current licensing transaction stamp value in a license database 124.

In a step 146, the processor 110 may transmit a signal to the NE 108a indicative of a restore request for the NE 108a to restore a backup image of the NE 108a including a backup license configuration having a backup licensing transaction stamp value.

In a step 148, the processor 110 may receive a signal over the network 104 from the NE 108a, the signal indicative of a restored license configuration of the NE 108a including the backup license configuration having the backup licensing transaction stamp value.

In a step 150, the processor 110 may read the current license configuration for the NE 108a and the restored license configuration for the NE 108a and may determine whether a discrepancy exists between the restored licensing transaction stamp value received from the NE 108a and the current licensing transaction stamp value of the NE 108a stored in the license database 124.

In a step 152, in response to a discrepancy between the restored licensing transaction stamp value and the current licensing transaction stamp value existing, the processor 110 may disable at least one feature of the NE 108a and may generate an alert and transmit the alert to a user via an output port. In some embodiments, step 152 may include the processor 110 blocking the NE 108a in response to the discrepancy existing.

For example, the processor 110 may compare the restored license configuration with the current license configuration to determine whether a discrepancy exists between the backup licensing transaction stamp value and the current licensing transaction stamp value. In some embodiment, the licensing transaction request may be a license key activation request including an activation code which may be indicative of a license key to be added on the NE 108a, a NE identifier uniquely identifying the NE 108a, and a location identifier uniquely identifying a location of the NE 108a in the network 104. Further, in some embodiments the licensing transaction message may be a license key removal request identifying at least one license key to be removed from the NE 108a.

In some embodiments, the processor 110 may also access a master license configuration stored in a non-transitory processor readable medium, synchronize the restored license configuration with the master license configuration to determine a corrected license configuration, store the corrected license configuration as the current license configuration of the NE 108a in the non-transitory processor readable medium 112, transmit a signal to the NE 108a indicative of a licensing transaction message including the corrected current license configuration. The NE 108a may update the licensing configuration and update (e.g., increment) the current licensing transaction stamp value and transmit a signal to the processor 110 indicative of the updated licensing transaction stamp value. In response thereto, the processor 110 may enable at least one feature on the NE 108a. The current licensing transaction stamp value may be incrementally changed with each licensing transaction by the NE 108a.

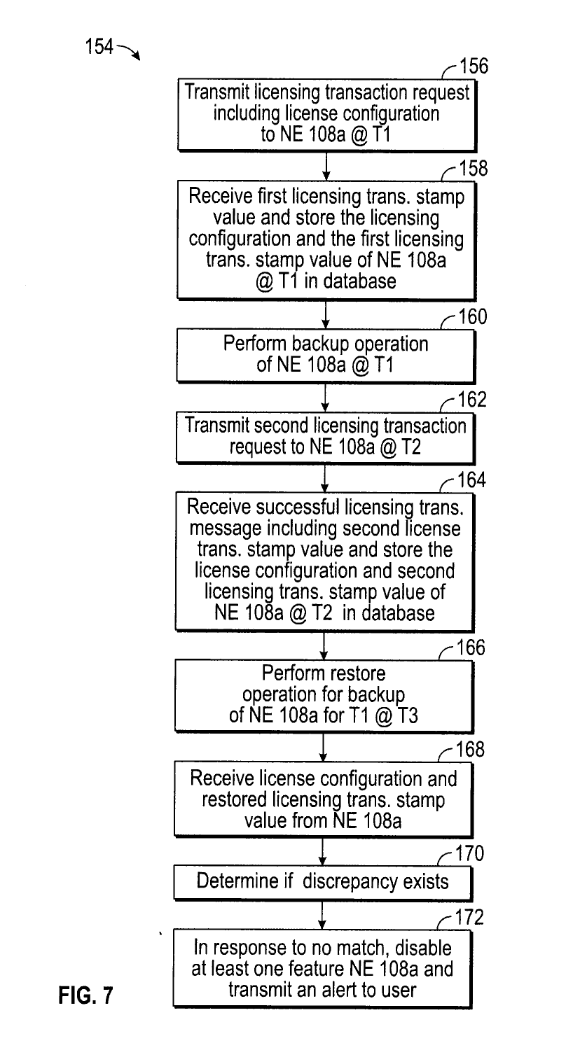

Referring now to FIG. 7, an exemplary embodiment of a method 154 of managing a license configuration of a NE 108a by a license management system 100 according to the inventive concepts disclosed herein may include one or more of the following steps.

In a step 156, a license manager 102 comprising at least one processor 110 capable of executing processor executable code may transmit a signal indicative of a first licensing transaction request including a first license configuration to a NE 108a coupled with a network 104 at a first instant in time.

In a step 158, the license manager 102 may receive a message from the NE 108a indicative of a successful licensing transaction and of a first licensing transaction stamp value and may store the first license configuration and the first licensing transaction stamp value in a non-transitory processor-readable medium 112.

In a step 160, the license manager 102 may perform a backup operation of the NE 108a by storing a backup image of the NE 108a at a second instant in time later than the first instant in time, the backup image including the first license configuration and the first licensing transaction stamp value.

In a step 162, the license manager 102 may transmit a signal indicative of a second licensing transaction request including a second license configuration to the NE 108a at a third instant in time later than the second instant in time, the second license configuration being different from the first licensing configuration.

In a step 164, the license manager 102 may receive a message from the NE 108a indicative of a successful licensing transaction and of a second licensing transaction stamp value and may store the second license configuration and the second licensing transaction stamp value in the non-transitory processor-readable medium 112.

In a step 166, the license manager 102 may perform a restore operation of the NE 108a by restoring the backup image of the NE 108a including the first license configuration and the first licensing transaction stamp value.

In a step 168 the license manager 102 may receive a signal indicative of a third license configuration from the NE 108a, the third license configuration indicative of the restored backup license configuration of the NE 108a and of the restored licensing transaction stamp value.

In a step 170, the license manager 102 may determine whether the third license configuration matches the stored second license configuration for the NE 108a.

In a step 172, in response to the third license configuration not matching the second license configuration, the license manager 102 may disable at least one feature of the NE 108a and may generate and alert and/or transmit the alert to a user via an output port.

The first licensing transaction request may be a license key activation request, and the first license configuration may include at least one license key to be activated on the NE 108a, a unique identifier identifying the NE 108a, and a NE location identifier uniquely identifying a location of the NE 108a in the network 104.

The second licensing transaction request may be a license key removal request, and the second license configuration may include at least one license key to be removed or deactivated from the NE 108a.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

It is to be understood that the steps disclosed herein may be performed simultaneously or in any desired order, and may be carried out by a human, or by a machine, and combinations thereof, for example. For example, one or more of the steps disclosed herein may be omitted, one or more steps may be further divided in one or more sub-steps, and two or more steps or sub-steps may be combined in a single step, for example. Further, in some exemplary embodiments, one or more steps may be repeated one or more times, whether such repetition is carried out sequentially or interspersed by other steps or sub-steps. Additionally, one or more other steps or sub-steps may be carried out before, after, or between the steps disclosed herein, for example.

Further, while implementations have been described in the context of an optical network, this need not be the case. These implementations may apply to an electronic network using copper cabling, or even a wireless network.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A license management system coupled with a network and having at least one processor capable of executing processor-executable code coupled with a non-transitory processor-readable medium storing processor-executable code for causing the at least one processor to:
access a current licensing transaction stamp value of a network element and a restored licensing transaction stamp value of the network element;
determine whether a discrepancy exists between the restored licensing transaction stamp value and the current licensing transaction stamp value; and
in response to the discrepancy between the restored licensing transaction stamp value and the current licensing transaction stamp value, transmit an alert to a user via an output port.

2. The license management system of claim 1, wherein the non-transitory processor-readable medium further stores processor executable code for causing the at least one processor to disable at least one feature of the network element in response to the discrepancy between the restored licensing transaction stamp value and the current licensing transaction stamp value.

3. The license management system of claim 2, wherein the non-transitory processor-readable medium further stores processor-executable code for causing the at least one processor to:
transmit a first signal over the network to the network element at a first instant in time, the first signal indicative of a licensing transaction request and including a requested license configuration;
store the requested license configuration as a current license configuration in a license database;
receive a second signal from the network element indicative of the current licensing transaction stamp value;
store the current licensing transaction stamp value in the license database; and
transmit a third signal to the network element indicative of a restore request for the network element to restore a backup image of the network element taken at a second instant in time earlier than the first instant in time and including the restored licensing transaction stamp value.

4. The license management system of claim 3, wherein the non-transitory processor-readable medium further stores processor executable code for causing the at least one processor to:
in response to the discrepancy between the restored licensing transaction stamp value and the current licensing transaction stamp value, disable at least one feature of the network element;
synchronize a current license configuration of the network element with a master license configuration of the network element to determine a corrected license configuration of the network element;
store the corrected license configuration as the current license configuration of the network element;
transmit a fourth signal to the network element indicative of the current license configuration; and
enable the at least one feature of the network element.

5. A method of managing a license configuration of a network element, comprising:
accessing, by at least one processor of a license manager, a current licensing transaction stamp value of a network element and a restored licensing transaction stamp value of the network element;
determining by the at least one processor, whether a discrepancy exists between the restored licensing transaction stamp value and the current licensing transaction stamp value; and
in response to the discrepancy between the restored licensing transaction stamp value and the current licensing transaction stamp value configuration, transmitting by the license manager an alert to a user via an output port.

6. The method of claim 5, further comprising disabling at least one feature the network element in response to the discrepancy between the restored licensing transaction stamp value and the current licensing transaction stamp value.

7. The method of claim 5, further comprising:
transmitting, by the at least one processor of the license manager, a first signal over the network to the network element at a first instant in time, the first signal indicative of a licensing transaction request including a requested license configuration;
receiving a second signal over the network from the network element indicative of a current licensing transaction stamp value of the network element;
storing the current licensing transaction stamp value of the network element in a license database; and
transmitting a second signal to the network element indicative of a restore request for the network element to restore a backup image of the network element taken at a second instant in time earlier than the first instant in time and including the restored licensing transaction stamp value.

8. The method of claim 7, further comprising:
in response to the discrepancy between the restored licensing transaction stamp value and the current licensing transaction stamp value, the license manager disabling at least one feature of the network element;
synchronizing, by the license manager, a current license configuration of the network element with a master license configuration of the network element to determine a corrected license configuration of the network element;
storing the corrected license configuration as the current license configuration of the network element by the license manager;
transmitting by the license manager a third signal to the network element indicative of the current license configuration; and
enabling the at least one feature of the network element by the license manager.
